(19) United States
(12) Patent Application Publication
(10) Pub. No.: US 2005/0056112 A1
(43) Pub. Date: Mar. 17, 2005

(54) Lever apparatus

(75) Inventor: Kiyohiro Mandou, Saitama (JP)

Correspondence Address: David W. Heid;MacPHERSON KWOK CHEN & HEID LLP, Suite 226, 1762 Technology Drive, San Jose, CA, 95110, US

(73) Assignee: HONDA MOTOR CO., LTD., Tokyo (JP)

(21) Appl. No.: 10/933,901

(22) Filed: Sep. 2, 2004

(30) Foreign Application Priority Data
Sep. 11, 2003 (JP) P.2003-319152

(51) Int. Cl. G05G 1/00; B60K 26/00

(52) U.S. Cl. 74/491; 180/315

(57) ABSTRACT

A lever cover 39 formed of a synthetic resin such as ABS as a material is allowed to pass along a lever shaft 39, and the lever cover 39 is fitted and held on a lever base 32. An exterior surface of the lever cover 39 is formed into a spherical surface which is defined about a pivot center P (an oscillation center of a lever main body 3). A shift panel 4 is an extrusion molded product of a synthetic resin as a material thereof and has at a central portion thereof a rectangular opening 41 through which the lever main body 3 is allowed to extend and which is larger than a large-diameter portion of a shift knob 38. A peripheral edge portion 42 of the opening 41 confronts the lever cover 39 with a certain gap provided therebetween.

### BACKGROUND OF THE INVENTION

The present invention relates to a lever apparatus provided for driving and operating an automobile or the like, and more particularly to a technique for improving the operation feeling.

In automobiles or small marine vessels in which a manual transmission is installed, a shift lever apparatus is provided near the driver's seat for operation by the driver when he or she performs a gear shift operation (gear selection and shift operations). In the shift lever apparatus, while an operation mechanism is connected to a lower end of a lever main body, the lever main body extends through an opening formed in a floor console or an instrument panel (hereinafter, referred to as an interior panel) so as to be exposed into the passenger compartment side. Since the opening in the interior panel is formed to a size which encompasses a moving range of the lever main body, a flexible boot is interposed between the opening and the lever main body in order to prevent the ingress of dust into the operation mechanism and to improve the appearance (for example, refer to a patent literature No. 1).

[Patent Literature No. 1]

JP-A-9-301004 (paragraph 0014, FIG. 1)

In the conventional shift lever apparatus, the following problems are caused due to the utilization of rubber, cloth and leather as materials for the boot. For example, in a case where rubber, which is an elastic body, is used for the material of the boot, since the restoring force of the boot constitutes an operating reaction force, light gear selecting and shifting operations are interrupted. In addition, since the hardness of rubber changes depending on temperatures, the operation feeling changes depending on environment where it exists; for example, the rigidity thereof decreases as the temperature inside the passenger compartment decreases. On the other hand, also in a case where cloth or leather is used in addition to rubber, a deterioration due to aging is inevitable, and therefore, in many cases, the boot tends to be broken or to get dirty and damaged.

### SUMMARY OF THE INVENTION

The invention is made in view of these situations, and an object thereof is to provide a lever apparatus which is intended to improve the operation feeling.

According to a first aspect of the invention, there is provided a lever apparatus comprising a lever main body adapted to oscillate about an oscillation center as a fulcrum relative to a base bracket, a spherical cover through which the lever main body extends and whose exterior surface is formed into a spherical surface which is defined substantially about the oscillation center as its center, and a stationary side panel having an opening through which the lever main body passes and which does not move relative to the base bracket, wherein a peripheral edge portion of the opening confronts the spherical cover with a certain gap provided therebetween.

According to the construction, since the gap between the lever main body and the stationary side panel is closed with the spherical cover, there is no need to interpose a boot between the two members.

According to a second aspect of the invention, there is provided a lever apparatus as set forth in the first aspect of the invention, wherein a seal unit is provided at the peripheral edge portion of the opening in such a manner as to slide contact the spherical surface.

According to the construction, the ingress of dust or the like into the operation mechanism is prevented.

According to a third aspect of the invention, there is provided a lever apparatus as set forth in the first or second aspect of the invention, wherein a knob is provided at an upper end portion of the lever main body, and wherein the opening is formed to a size which allows for the passage of the knob.

According to the construction, for example, the knob and the lever main body can be incorporated into a single sub-assembly.

According to a fourth aspect of the invention, there is provided a lever apparatus as set forth in any of the first to third aspects of the invention, wherein the stationary side panel is an interior panel.

According to the construction, the lever apparatus does not need to be covered with another interior panel after the lever apparatus is assembled to the vehicle or the like.

According to the lever apparatus described above, the change in operation feeling and deterioration in durability which are attributed to the utilization of the boot can be prevented, and furthermore, a novel design can be obtained.

### BRIEF DESCRIPTION OF THE DRAWINGS

FIG. 1 is a perspective view illustrating a shift lever apparatus according to the embodiment.

FIG. 2 is a side view of the shift lever apparatus with a shift panel being shown in a cross-sectional view.

FIG. 3 is a vertical cross-sectional view of the same shift lever apparatus.

FIG. 4 is a cross-sectional view taken along the line A-A in FIG. 2.

FIG. 5 is an enlarged view of a portion B in FIG. 2.

FIG. 6 is a perspective view illustrating an assembling procedure of the same shift lever apparatus.

### DETAILED DESCRIPTION OF THE PREFERRED EMBODIMENTS

Hereinafter, referring to the drawings, the invention will be described in detail based on an embodiment in which the invention is applied to an automobile remote controlled gear shift lever apparatus.

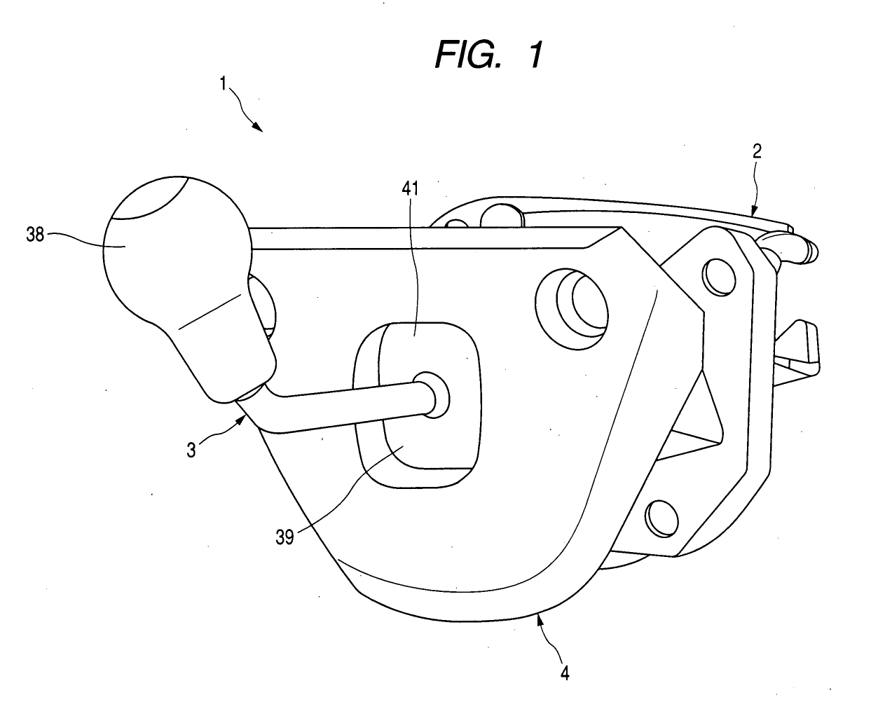

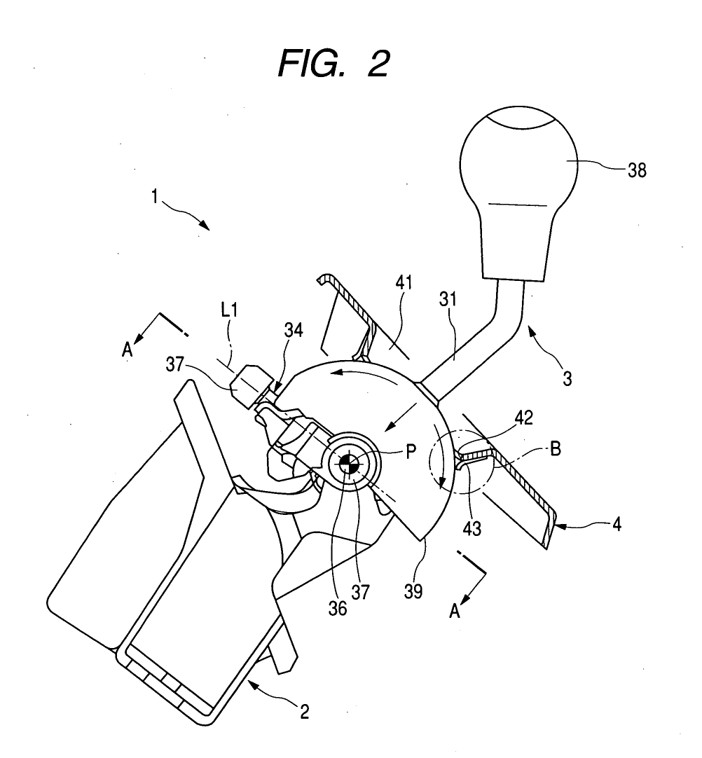

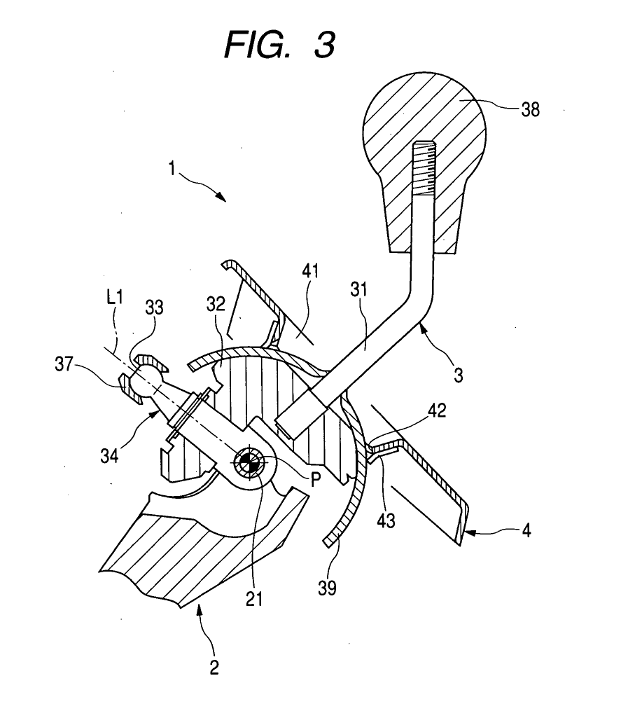

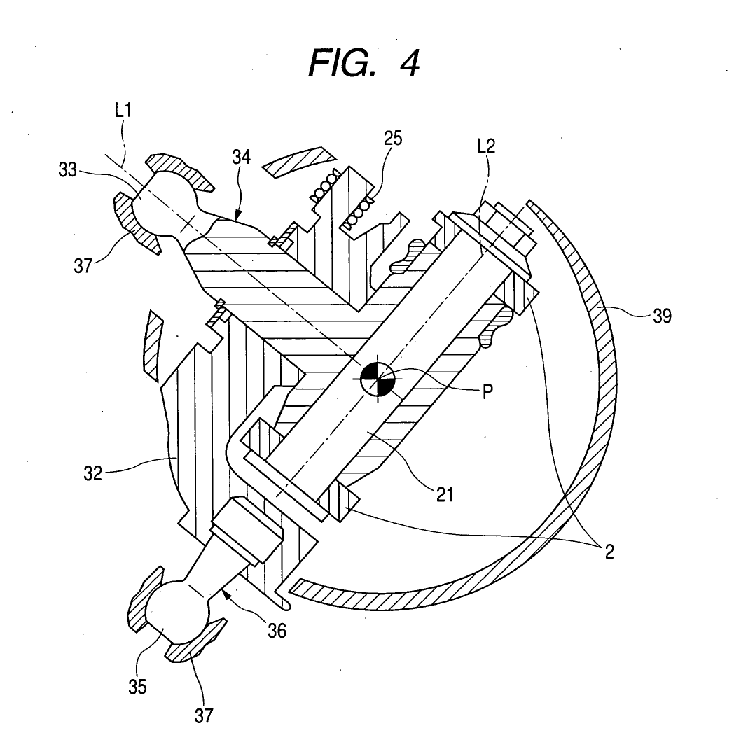

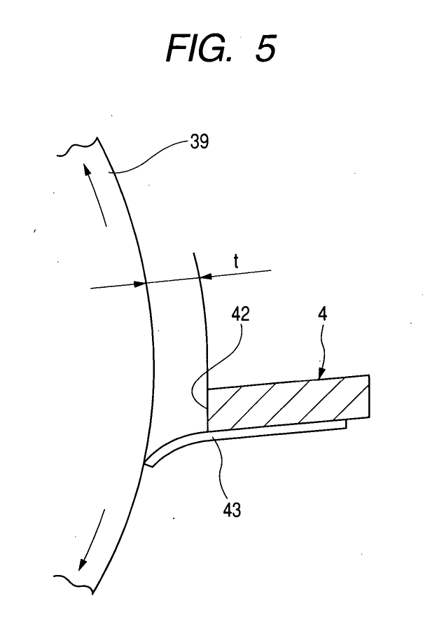

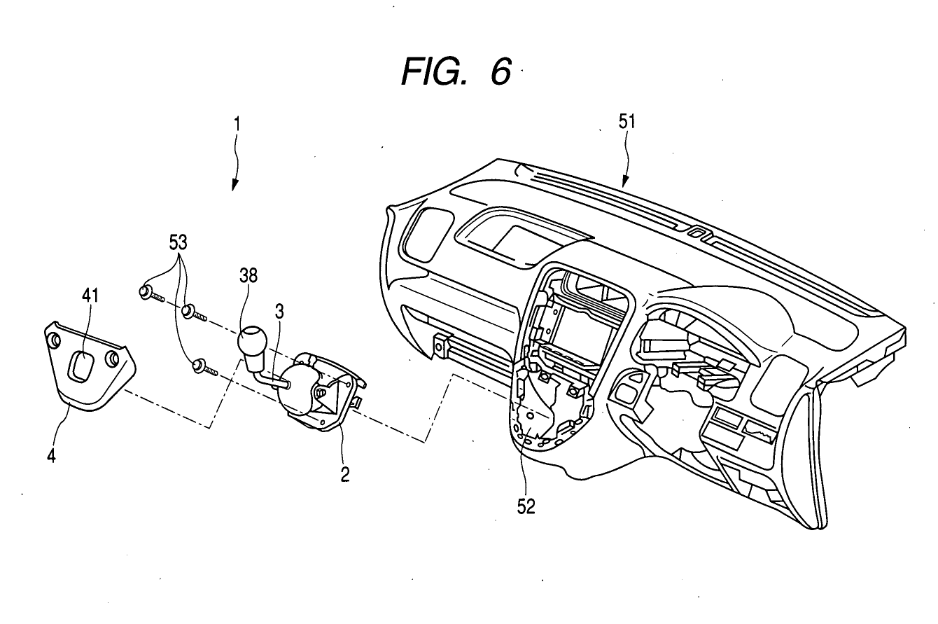

FIG. 1 is a perspective view illustrating a shift lever apparatus according to the embodiment, FIG. 2 is a side view of the shift lever apparatus with a shift panel being shown in a cross-sectional view, FIG. 3 is a vertical cross-sectional view of the same shift lever apparatus, FIG. 4 is a cross-sectional view taken along the line A-A in FIG. 2, FIG. 5 is an enlarged view of a portion B in FIG. 2, and FIG. 6 is a perspective view illustrating an assembling procedure of the same shift lever apparatus.

As shown in FIG. 1, a shift lever apparatus 1 includes, as main constituent members thereof, a base bracket 2 which is fixed to an instrument panel, which will be described later on, a lever main body 3, which is supported on the base bracket 2 in such a manner as to freely oscillate, and a shift panel (an interior panel (a stationary side panel)) 4, which is fixed to the instrument panel, not shown.

As shown in FIG. 3, the lever main body 3 is such that a synthetic resin lever base 32 is integrally injection molded on a steel lever shaft 31 and is supported by a pivot lever 34 in such a manner as to freely oscillate. As shown in FIGS. 2, 3, a steel selecting pin 36 is integrated into the pivot lever 34, and when the lever main body 3 oscillates about a center axis L1 of the pivot lever 34 as its axis through a selecting operation by the driver, a selection control wire (not shown) is driven which is connected to a spherical surface portion 35 formed at a distal end of the selecting pin 36 via a wire bush 37. As shown in FIGS. 1 to 3, a shift knob (a knob) 38 is screwed on to a distal end of the lever shaft 31 in a sub-assembly state, and the driver grips this shift knob 38 to operate the lever main body 3.

As shown in FIGS. 3, 4, the pivot lever 34 is supported on the base bracket 2 via a pivot pin 21 in such a manner as to freely oscillate. When the pivot lever 34 oscillates about a center axis L2 of the pivot pin as its axis through a shifting operation by the driver, a shift control wire (not shown) is driven which is connected to a spherical surface portion 33 formed at a distal end of the pivot lever 34 via a wire bush 37. As shown in FIG. 4, in this embodiment, the center axis L1 of the pivot lever 34 and the center axis L2 of the pivot pin 21 intersect with each other at a pivot center P. Note that a member denoted by reference numeral 25 in FIG. 4 is a return spring for holding the lever main body 3 at a neutral position in selecting directions.

As shown in FIG. 3, a lever cover (a spherical cover) 39, which is formed, as a material thereof, of a synthetic resin such as ABS is passed along the lever shaft 31, and the lever cover 39 is fitted and held on the lever base 32. An exterior surface of the lever cover 39 is formed into a spherical surface which is defined about the pivot center P (the oscillation center of the lever main body 3) as its center, and a plating is applied to the surface thereof so as to function as a wear-resistant means as well as a decoration.

The shift panel 4 is an injection molded product of a synthetic resin as a material thereof and, as shown in FIG. 1, has at a central portion thereof an opening 41 through which the lever main body 3 is allowed to extend and which is formed into a rectangular shape larger than a large-diameter portion of the shift knob 38. As shown in FIG. 5, a peripheral edge portion 42 of the opening 41 confronts the lever cover 39 with a certain gap “t” being provided therebetween. In addition, a dust seal (a seal unit) 43, which is formed of a material such as a low friction material including PTFE (polytetrafluoroethylene resin), is securely affixed to an outer surface of the peripheral edge portion 42 of the opening 41, and the dust seal 43 slide contacts the surface of the lever cover 39.

In this embodiment, when the shift lever apparatus 1 is assembled to an automobile, an assembly made up of the lever main body 3 and the base bracket 2 to which the selection control wire and the shift control wire are assembled, respectively, is, as shown in FIG. 6, inserted into a shift lever mounting opening 52 provided in a lower portion of an instrument panel 51, and the base bracket 2 is fastened to an operation mechanism, not shown, with three bolts 53. Thereafter, when the shift panel 4 is fitted in the instrument panel 51 with the shift knob 38 being allowed to pass through the opening 41, the assembling work is completed.

In this embodiment, when the driver grips the shift knob 38 to operate the lever main body 3, the lever cover 39 oscillates together with the lever main body 3 in a selecting direction or shifting direction. As this occurs, since the exterior surface thereof is formed into the spherical surface which is defined about the pivot center P as its center, the lever cover 39 is allowed to confront the peripheral edge portion 42 the opening 41 with the certain gap “t” being provided therebetween, and the dust seal 43 is allowed to slide contact the surface of the lever cover 39 under a certain pressure.

Thus, in this embodiment, since the boot, which is used on the conventional apparatus, is removed, there occurs no risk that the operation feeling of he lever main body 3 changes depending on passenger compartment temperatures and also there scarcely occurs a risk that the constituent components get dirty or damaged due to the deterioration with time. Furthermore, the ingress of dust from the gap between the opening 41 in the shift panel 4 and the lever cover 39 into the operation mechanism is prevented. In addition, in this embodiment, in contrast to the conventional apparatus in which a shift knob is screwed on a lever main body after a boot is assembled to a base bracket 2, since the assembly of the lever main body 3 and the base bracket 2 including the shift knob 38 as well is assembled as a sub-assembly, the assembling work of the shift lever apparatus 1 on a vehicle assembling line is improved remarkably.

Thus, while the specific description of the embodiment is completed, the aspect of the invention is not limited to the embodiment so described. For example, while the embodiment is described as being applied to the automobile wire-driven remote controlled shift lever apparatus, the invention may be applied to a rod-driven remote controlled shift lever apparatus or a direct-action shift lever apparatus. In addition, the invention may be applied to a shift lever apparatus for small marine vessels or a lever apparatus other than the shift lever apparatus. Furthermore, while, in the embodiment, the base bracket and the shift panel are fixed to the instrument panel, respectively, the shift panel may be fastened to the base bracket so as to be incorporated theretinto, and the integrated unit so constructed may be fixed to a structural member (such as a floor tunnel) on the vehicle body side. Moreover, appropriate modifications may be made not only to the material and configuration of the constituent components but also to the specific constructions without departing from the spirit and scope of the invention.

1. A lever apparatus comprising:
a lever main body adapted to oscillate about an oscillation center as a fulcrum relative to a base bracket;
a spherical cover through which the lever main body extends and whose exterior surface is formed into a spherical surface which is defined substantially about the oscillation center as a center thereof; and
a stationary side panel having an opening through which the lever main body passes and which does not move relative to the base bracket; wherein
a peripheral edge portion of the opening confronts the spherical cover with a certain gap provided therebetween.

2. The lever apparatus as set forth in claim 1, further comprising:
a seal unit provided at the peripheral edge portion of the opening in such a manner as to slide contact the spherical surface.

3. The lever apparatus as set forth in claim 1, further comprising:
a knob provided at an upper end portion of the lever main body, wherein
the opening is formed to a size which allows for the passage of the knob.

4. The lever apparatus as set forth in claim 1, wherein
the stationary side panel is an interior panel.
